(19) United States
(12) Patent Application Publication
(10) Pub. No.: US 2014/0170289 A1
(43) Pub. Date: Jun. 19, 2014

(54) EDIBLE FOAMABLE COMPOSITIONS COMPRISING CALCIUM CARBONATE

(71) Applicant: RICH PRODUCTS CORPORATION, Buffalo, NY (US)

(72) Inventors: Michael P. Piatko, West Seneca, NY (US); Dmitry Falkov, Saint Petersburg (RU); Ilya Ilyin, Brookline, MA (US); Pavel Koblents, Saint Petersburg (RU); Shawn Campell, Burlington (CA); Mary Toerne, Williamsville, NY (US); Bernard P. Binks, Hull (GB); Saeed Mashinchi, Hull (GB)

(73) Assignee: RICH PRODUCTS CORPORATION, Buffalo, NY (US)

(21) Appl. No.: 14/132,706

(22) Filed: Dec. 18, 2013

Related U.S. Application Data
(60) Provisional application No. 61/739,219, filed on Dec. 19, 2012.

(51) Int. Cl. A23L 1/19

(52) U.S. Cl. CPC A23L 1/19
USPC 426/548; 426/564

(57) ABSTRACT

An edible foamable composition that is whippable and is stable in temperature above freezing. The composition includes fat, emulsifier, water, and calcium carbonate particles. The composition can further including one or more additives selected from the group consisting of preservatives, protein, salt, flavoring, coloring agent, sweetener, stabilizer and thickener.

The present invention claims priority on U.S. Provisional Application Ser. No. 61/739,219 filed Dec. 19, 2012, which is incorporated herein.

The invention relates generally to the field of edible foaming compositions, particularly to edible foamable compositions that have improved foam stability, extended handling time and/or reduced fat content, and still more particularly to an edible foamable composition that has improved foam stability, extended handling time and reduced fat content, and which includes calcium carbonate.

### BACKGROUND OF THE INVENTION

One of the requirements for food foams that are used to prepare confectionary creams, marshmallows, ice creams, etc. is foam stability. As such, it is desirable that attributes such as volume, shape, smooth surface and organoleptic features be retained over a period of time in fresh, as well as stored, products. Stabilizing foam by utilizing specialized additives (stabilizers) is a well-known method to enhance foam stability. From the standpoint of foam reinforcement, the stabilizers can be subdivided into the following groups: i) substances that enhance the viscosity of the foamed composition (thickeners), for example, glycerin and cellulose derivatives; ii) substances that form colloids in foam films thereby decreasing the drying time for the foam, for example, gelatin, starch, and agar-agar; iii) substances that are polymerized in the volume of the foam, for example, synthetic tars and latexes; iv) substances that produce non-water-soluble, high-dispersion sediments when combined with foam thereby reinforcing foam films and hindering their degradation, for example, salts of heavy metals: iron, copper, barium, and aluminum; and v) finely atomized solid substances, which when uniformly distributed over the surface of gas bubbles, reinforce foam films and strengthen the foam (A. P. Merkin, P. R. Taube. Fragile Miracle.—M.: “Chemistry publishers,” 1983).

Previously, foams have been stabilized by using colloidally dispersed solid particles without surfactants with varying results. Du et al., Langmuir, v. 19, 3106-3108 (2003), discloses that silicon earth particles having a diameter of 20 nm have been used as foam stabilizers. The article discloses that during foaming, bubbles were generated under the water-gas surface in such a way that a portion of the bubbles were coated with silicon particles. However, the percentage of stabilized bubbles was found to be very small. Binks et al. (Chem. Int. Ed., v. 44, 3722-3725 (2005)) describes particles of silicon earth (20-50 nm in size) wherein the surface of the particles was modified to ensure that the particles have a certain degree of hydrophobicity. The size of the bubbles was approximately 5-50 μm, while the foam was described as being stable in relation to coalescence and diffusion-based gas transfer between the different diameter bubbles. Foams and emulsions stabilized by solid silicon particles are also described in WO 2007/068127.

EP1668992A1 describes a food composition comprising water, an emulsion, and solid inert particles that stabilize the foam. Solid particles are used to stabilize a preformed emulsion such as dairy cream.

US 2010/0178410 discloses an edible foamable composition that includes clay particles. The clay particles used were about 1-25 nm and created stable foams for up to 4 days.

Other prior art has also disclosed the formation of food products that include the use of various edible particles, namely EP 1999544; EP 1889544; EP 1759591; WO 2008/046742; WO 2008/046732; WO 2008/046699; WO 2008/046698; WO 2007/068344 and WO 2007/068127.

### SUMMARY OF THE INVENTION

The present invention is directed to an edible foamable composition that has improved foam stability, extended handling time and/or reduced fat content, and which edible foamable composition includes calcium carbonate. In one non-limiting embodiment of the invention, there is provided an edible foam composition that includes fat, emulsifier, water, and calcium carbonate particles. Other components can also be included in the edible foamable composition such as, but not limited to, preservatives, protein, salt, flavoring, coloring agent, sweetener, stabilizer, thickener, and the like.

In one non-limiting aspect of the invention, the fat content of the edible foam composition is generally at least about 0.1% by weight and is generally no more than about 50% by weight (e.g., 0.1%, 0.101%, 0.102% . . . 49.998%, 49.999%, 50%) and any value or range therebetween. Typically, the fat content of the edible foam composition is about 0.1%-50% by weight of the composition, more typically about 1%-40% by weight of the composition, still more typically 5%-35% by weight of the composition, yet more typically 8%-30% by weight of the composition, and yet still more typically 10%-20% by weight of the composition. The fat source can be from one or more sources such as, but not limited to, vegetable, plant, algal, fungal, bacterial, nut and/or animal origin. Non-limiting examples of suitable fats include fractionated, interesterified, unhydrogenated, partially or fully hydrogenated fat (e.g., palm, palm kernel, coconut, milk fat, soy, cottonseed, canola, corn, sunflower, safflower, nuts, beans, and other vegetable or animal fats or blend of fats thereof).

In another and/or alternative non-limiting aspect of the invention, the calcium carbonate particle content is generally at least about 0.01% by weight and generally up to about 10% by weight (e.g., 0.01%, 0.0101%, 0.0102% . . . 9.998%, 9.999%, 10%) and any value or range therebetween. Typically, the calcium carbonate particle content is up to about 5% by weight of the composition, more typically about 0.1-1% by weight of the composition, yet more typically about 0.2-0.8% by weight of the composition, and still yet more typically about 0.25-0.5% weight of the composition. In one non-limiting specific example, the calcium carbonate particle content is about 0.95%-1.05% by weight of the composition. The calcium carbonate particles generally have an aspect ratio that is generally less than about 20, typically less than about 15, more typically less than about 10, still more typically no more than about 9, still yet more typically no more than about 5, and further typically no more than about 2. The calcium carbonate may or may not be surface treated. If the surface of the calcium carbonate is treated, it can be treated with a variety of substances (e.g., fatty acids, saturated fatty acids [e.g., stearic acid, etc.], etc.). Such surface treatment is generally used to modify the surface activity of the calcium carbonate. The calcium carbonate generally has an average particle size of no more than about 10 microns (e.g., 0.001 microns, 0.0011 microns, 0.0012 microns . . . 9.9998 microns, 9.9999 microns, 10 microns, and any value or range therebetween), typically no more than about 5 microns, more typically no more than about 3 microns, still more typically no more than about 1 micron, and further more typically no more than about 0.5 microns. In one non-limiting specific example, the average particle size of the calcium carbonate particles is about 0.04-0.09 microns, and typically about 0.06-0.08 microns. The shape of the particles of calcium carbonate is not limiting. Non-limiting shapes include spherrulitic, rhombohedral, spherical, scalenohedral, cubic, needle forms, rosette, etc. The particles of calcium carbonate can be ground calcium carbonate and/or precipitated calcium carbonate (PCC).

In still another and/or alternative non-limiting aspect of the invention, a wide variety of emulsifiers can be used to form the oil-in-water emulsion. The content of the emulsifier is generally at least about 0.001% by weight and generally no more than about 5% by weight of the composition (e.g., 0.001%, 0.0011%, 0.0012% . . . 4.9998%, 4.9999%, 5%) and any value or range therebetween. Typically, the content of the emulsifier is about 0.05%-3% by weight of the composition, more typically about 0.1-1% by weight of the composition, and more typically about 0.15-0.5 by weight of the composition. Non-limiting examples of emulsifiers include lecithin, hydrolyzed lecithin; mono-, di-, or poly-glycerides of fatty acids, such as stearine and palmitin mono- and di-glycerides, polyoxyethylene ethers of fatty esters of polyhydric alcohols, such as the polyoxyethylene ethers of sorbitan monostearate (Polysorbate 60) or the polyoxyethylene ethers of sorbitan monooleate (Polysorbate 80); fatty esters of polyhydric alcohols such as sorbitan monostearate or tristearate; polyglycerol esters of mono- and di-glycerides such as hexaglyceryl distearate; mono- and/or diesters of glycols such as propylene glycol monostearate, and propylene glycol monopalmitate, succinoylated monoglycerides. In one non-limiting embodiment of the invention, the emulsifier includes anionic emulsifiers such as: the esters of carboxylic acids such as lactic, citric, and tartaric acids with the mono- and di-glycerides of fatty acids such as glycerol lacto palmitate and glycerol lacto stearate, and calcium or sodium stearoyl lactylates (e.g., sodium stearoyl-2-lactylate, etc.) and all members of the sucrose ester family thereof, all varieties of diacetyltartaric esters of fatty acids, “DATEMs”, and the like.

In yet another and/or alternative non-limiting aspect of the invention, the water content is generally at least about 25% by weight of the composition and generally no more than about 85% by weight of the composition (e.g., 25%, 25.01%, 25.02% . . . 84.98%, 84.99%, 85%) and any value or range therebetween. Typically, the water content is about 30%-80% by weight of the composition, and more typically about 35%-65% by weight of the composition. The water can be ionized water, deionized water, purified water, etc.

In still yet another and/or alternative non-limiting aspect of the invention, one or more proteins can be optionally included in the composition. Non-limiting examples of such proteins are proteins from animals, vegetables, nuts, and grains (e.g., sodium caseinate, potassium caseinate, calcium caseinate, milk protein concentrate, milk protein isolate, whey protein concentrate, whey protein isolate, soy protein, egg protein, animal protein, pea protein, wheat protein, cottonseed protein, peanut protein, corn protein, alpha lactalbumin, beta lactoglobulin, etc.). The protein, when included in the composition, is generally at least 0.01% by weight and generally up to about 15% by weight (e.g., 0.01%, 0.0101%, 0.0102% . . . 14.9998%, 14.9999%, 15%) and any value or range therebetween.

In another and/or alternative non-limiting aspect of the invention, one or more sweeteners can optionally be included in the composition. Non-limiting examples of sweetener includes lactose, sucrose, fructose, dextrose, sucrose, trehalose, maltose, sugar syrups, polydextrose, maltitol, erythritol, xylitol, mannitol, isomalt, lactitol, glycerin, propylene glycol, sorbitol, honey granule, honey powder, corn syrup, high fructose corn syrup, malt, and hydrolyzed corn syrup, liquid honey. As can be appreciated, artificial sweeteners, low or no calorie sweeteners can also or alternatively be used in the composition. The sweetener, when included in the composition, is generally at least 0.01% by weight and generally up to about 75% by weight (e.g., 0.01%, 0.0101%, 0.0102% . . . 74.9998%, 74.9999%, 75%) and any value or range therebetween.

In still another and/or alternative non-limiting aspect of the invention, one or more stabilizers and/or thickeners can be optionally included in the composition. Non-limiting examples of stabilizers and/or thickeners include TiO₂, cellulose, gum arabic, carboxymethylcellulose (CMC), gellan gum, guar gum, xanthan gum, alginate, locust bean gum, hydrophilic colloids, carrageenan, methylcellulose (MCC), ethylcellulose, hydroxy-propylmethylcellulose, microcrystalline cellulose. The stabilizers and/or thickener, when included in the composition, is generally at least 0.001% by weight and generally up to about 5% by weight (e.g., 0.001%, 0.0011%, 0.0012% . . . 4.9998%, 4.9999%, 5%) and any value or range therebetween.

In yet another and/or alternative non-limiting aspect of the invention, the edible foam composition is stable for at least 0.5 days at temperatures of above freezing and up to 30° C. For purposes of this invention, stable is defined as the whipped composition maintaining at least 50% of its overrun value over a period of time. For example, if the whipped composition has an overrun of 200% after the whipping process, the whipped composition is considered stable for at least 1 day if the overrun of the whipped composition is at least 100% for one day after the composition had been whipped. In one non-limiting embodiment, the edible foam composition is stable for at least 1 day at temperatures of above freezing and up to 30° C., typically the edible foam composition is stable for at least 2 days at temperatures of above freezing and up to 30° C., and more typically the edible foam composition is stable for at least 4 days at temperatures of above freezing and up to 30° C. In another non-limiting embodiment, the edible foam composition is stable for at least up to about 28 days at temperatures of above freezing and up to 30° C., and more typically the edible foam composition is stable for at least up to about 21 days at temperatures of above freezing and up to 30° C. In one specific example, the edible foam composition is stable for at least about 1 day and at least up to about 21 days at temperatures of above freezing and up to 30° C. (1 day, 1.01 days, 1.02 days . . . 20.98 days, 20.99 days, 21 days) and all values and ranges therebetween. Furthermore, such foams can maintain their integrity upon application of mechanical shear forces applied from a pastry bag or other type of mechanical dispensers after at least 0.5 hours at temperatures of above freezing and up to 30° C. In one non-limiting embodiment, the edible foam composition can maintain its integrity upon application of mechanical shear forces applied from a pastry bag or other type of mechanical dispensers after 1 hour at temperatures of above freezing and up to 30° C., typically at least 2 hours at temperatures of above freezing and up to 30° C., and more typically the edible foam composition is stable for at least 8 hours at temperatures of above freezing and up to 30° C. In another non-limiting embodiment, the edible foam composition can maintain its integrity upon application of mechanical shear forces applied from a pastry bag or other type of mechanical dispensers for at least up to about 2 days at temperatures of above freezing and up to 30° C., and more typically for at least up to about 1 day at temperatures of above freezing and up to 30° C. In one specific example, the edible foam composition can maintain its integrity upon application of mechanical shear forces applied from a pastry bag or other type of mechanical dispensers for at least about 1 hour and at least up to about 24 hour at temperatures of above freezing and up to 30° C. (1 hour, 1.01 hour, 1.02 hour . . . 23.98 hours, 23.99 hours, 24 hours) and all values and ranges therebetween. While not being held to any particular theory, formulations containing calcium carbonate have been shown to impart additional stability to syneresis to the whipped products even at elevated water levels.

The present invention provides a foamable food composition having enhanced stability at ambient temperatures and also exhibiting enhanced stability when mechanical shear forces are applied to the foam. The foamable food compositions comprise oil, water, emulsifier, and calcium carbonate. While not intending to be bound by any particular theory, it is believed that when the composition is whipped, a three-phase emulsion is obtained wherein the oil globules are concentrated at the aqueous (e.g., oil, water, etc.)/gas (e.g., air, nitrogen, carbon dioxide, nitrous oxide, propane, etc.) interface and ensure stability of foam structure. It is also believed that the similarity in particle size of the calcium carbonate and fat globules/aggregates in the system can also result in improved stability of the foam. The calcium carbonate is believed to occupy the interstices between the air cells much in the same manner as the fat does, thus creating improved foam stability while also being able to reduce the fat content of the foam.

When preparing the composition, solid particles are generally added in the aqueous phase and/or in the oil phase of the composition. To simplify addition of the calcium carbonate, the calcium carbonate can optionally be dispersed into the aqueous phase in advance. The calcium carbonate particles can optionally be added to the mix prior to formation of the emulsion. Therefore, the particles can optionally be added before the addition of any emulsifiers. Alternatively, the addition of the calcium carbonate can be added to the emulsion after the formation of the finished emulsion and at the time of whipping of the components. The emulsion may be aerated via batch or continuous methods. In addition to the ability of calcium carbonate to contribute to the mechanical destabilization and whipping of the emulsion, another manifestation of the invention is believed to revolve around the surface charge and activity of the calcium carbonate particle and its interaction with emulsifiers at the interface of the fat droplets. The calcium carbonate is believed to act as a destabilizing agent during the whipping process, especially in the presence of anionic surfactants and negatively-charged proteins to induce partial coalescence.

Testing of calcium carbonate (e.g., precipitated calcium carbonate—PCC) has shown benefits to the performance of non-dairy whipped toppings and icings. The test results from the addition of calcium carbonate indicated that, when used in combination with a reduction of fat level by one third or more, the calcium carbonate increased the stability and bench time of the foam structure at elevated ambient temperatures (20° C.-25° C.). The calcium carbonate can be used to replace 0.01% of the fat in the composition and up to about 50% of the fat in the composition (e.g., 0.01%, 0.0101%, 0.0102% . . . 49.9998%, 49.9999%, 50%) and any value or range therebetween. Typically, the calcium carbonate is used to replace about 1%-40% of the fat in the composition, and more typically about 10%-25% of the fat in the composition. Bench time was measured in terms of the time, once the icing was removed from the refrigerator. The test indicated that the product remained spreadable and/or pipeable into smooth edged rosettes during cake decoration. As stated above the order manner in which the calcium carbonate is added to the formulation can be utilized to modify the properties of the whipped emulsion whether by addition to the oil or water phase during emulsion preparation or by addition thereafter during aeration. Calcium carbonate works well as a topping stabilizer and fat replacement. Repeatable good results were achieved for bag time of calcium carbonate stabilized topping at 20° C. (24 hours and more).

The composition of the present invention provides very good overrun. The composition of the present invention can be whipped at temperatures above freezing (e.g., 1° C.-30′C) to obtain overruns of greater than 150% and overruns up to 500% of more (e.g., 150%, 151%, 152% . . . 498%, 499%, 500% and any value or range therebetween). The whip composition has excellent stability times when in a non-frozen state. The composition can be frozen prior to being whipped, and/or be frozen after being whipped. Generally, the composition is whipped in a non-frozen state.

It is one non-limiting objective of the present invention to provide an edible foamable composition that has improved foam stability, extended handling time and/or reduced fat content.

It is another and/or alternative non-limiting objective of the present invention to provide an edible foamable composition that includes fat, emulsifier, water, and calcium carbonate particles.

It is still another and/or alternative non-limiting objective of the present invention to provide an edible foamable composition that optionally includes preservatives, protein, salt, flavoring, coloring agent, sweetener, stabilizer, thickener, and the like.

It is yet another and/or alternative non-limiting objective of the present invention to provide an edible foamable composition that includes calcium carbonate particles having an aspect ratio that is generally less than about 20, typically less than about 15, more typically less than about 10, still more typically no more than about 9, still yet more typically no more than about 5, and further typically no more than about 2.

It is still yet another and/or alternative non-limiting objective of the present invention to provide an edible foamable composition that includes calcium carbonate that may or may not be surface treated.

It is another and/or alternative non-limiting objective of the present invention to provide an edible foamable composition that has an average particle size of no more than about 10 microns, typically no more than about 5 microns, more typically no more than about 3 microns, still more typically no more than about 1 micron, and further more typically no more than about 0.5 microns.

It is still another and/or alternative non-limiting objective of the present invention to provide an edible foamable composition wherein the calcium carbonate is or includes precipitated calcium carbonate (PCC).

It is yet another and/or alternative non-limiting objective of the present invention to provide an edible foamable composition that is stable for at least 0.5 days at temperatures of above freezing and up to 30° C., generally stable for at least 1 day at temperatures of above freezing and up to 30′C, typically is stable for at least 2 days at temperatures of above freezing and up to 30° C., and more typically the edible foam composition is stable for at least 4 days at temperatures of above freezing and up to 30° C.

It is still yet another and/or alternative non-limiting objective of the present invention to provide an edible foamable composition that is stable for at least up to about 28 days at temperatures of above freezing and up to 30′C, and more typically the edible foam composition is stable for at least up to about 21 days at temperatures of above freezing and up to 30° C.

These and other objects and advantages will become apparent to those skilled in the art upon reading and following the present description and examples.

Several non-limiting examples of edible foaming compositions in accordance with the inventions are as follows:

### EXAMPLE 1

| | Desired | Broad | Specific |
|---|---|---|---|
| Ingredient | Range wt. % | Range wt. % | Range |
| Oil and/or fat | 12-20 | 5-40 | 15 |
| Emulsifier (e.g., Polyaldo HGDS, | 0.4-0.8 | 0-2 | 0.5 |
| Hydroxypropylmethyl cellulose, | | | |
| Sodium stearyol lactylate) | | | |
| Protein (e.g., Sodium caseinate) | 0.5-2 | 0.05-8 | 1 |
| Calcium carbonate | 0.3-0.7 | 0.05-15 | 0.7 |
| Stabilizers/Thickeners | 0.01-1 | 0-2 | 0.5 |
| (e.g., Xanthan gum) | | | |
| Preservative (e.g., Potassium | 0.05-0.2 | 0-1.5 | 0.1 |
| sorbate) | | | |
| Flavoring (e.g., Vanilla flavor) | 0.01-0.1 | 0-1.5 | 0.05 |
| Salt (e.g., Sodium chloride) | 0.05-0.15 | 0-1.5 | 0.1 |
| Water | 15-30 | 10-80 | 27.05 |
| Sweetener (e.g., High fructose | 40-60 | 0.001-75 | 55 |
| corn syrup, artificial sweetener) | | | |
| Total | 100 | 100 | 100 |

### EXAMPLE 2

| | Control | Test | Broad |
|---|---|---|---|
| Ingredient | wt. % | wt. % | Range wt. % |
| Palm kernel oil | 24 | 16 | 10-25 |
| Polyaldo HGDS | 0.1 | 0.1 | 0-1 |
| Sodium caseinate | 1.3 | 1.3 | 0-5 |
| Calcium carbonate | 0 | 0.5 | 0.05-10 |
| Hydroxypropylmethyl cellulose | 0.25 | 0.25 | 0-1 |
| Xanthan gum | 0.05 | 0.05 | 0-1 |
| Potassium sorbate | 0.1 | 0.1 | 0-1 |
| Vanilla flavor | 0.05 | 0.05 | 0-1 |
| Sodium chloride | 0.1 | 0.1 | 0-1 |
| Water | 23.8 | 31.3 | 15-60 |
| High fructose corn syrup | 50 | 50 | 0-60 |
| Sodium stearyol lactylate | 0.3 | 0.3 | 0-1 |
| Total | 100 | 100 | 100 |

### EXAMPLE 3

| Ingredient | Test wt. % | Broad Range wt. % |
|---|---|---|
| Palm kernel oil | 15 | 10-25 |
| Polyaldo HGDS | 0.1 | 0-1 |
| Sodium caseinate | 1.3 | 0-5 |
| Calcium carbonate | 0.5 | 0.05-10 |
| Hydroxypropylmethyl cellulose | 0.26 | 0-1 |
| Xanthan gum | 0.04 | 0-1 |
| Potassium sorbate | 0.1 | 0-1 |
| Vanilla flavor | 0.03 | 0-1 |
| Sodium chloride | 0.14 | 0-1 |
| Water | 47.23 | 15-60 |
| High fructose corn syrup | 0 | 0-60 |
| Dextrose | 35 | 0-60 |
| Sodium stearyol lactylate | 0.3 | 0-1 |
| Total | 100 | 100 |

### EXAMPLE 4

| Ingredient | Test wt. % | Broad Range wt. % |
|---|---|---|
| Palm kernel oil | 9.99 | 8-25 |
| Coconut oil | 0.76 | 0-25 |
| Polyaldo HGDS | 0 | 0-1 |
| Sodium caseinate | 1.2 | 0-5 |
| Calcium carbonate | 1.5 | 0.05-10 |
| Hydroxypropylmethyl cellulose | 0 | 0-1 |
| Xanthan gum | 0.25 | 0-1 |
| Guar gum | 0.22 | 0-1 |
| Potassium sorbate | 0 | 0-1 |
| Vanilla flavor | 0.35 | 0-1 |
| Cream flavor | 0.03 | 0-1 |
| Bavarian cream flavor | 0.05 | 0-1 |
| Sweet cream flavor | 0.005 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.02 | 0-1 |
| Water | 52.39 | 15-60 |
| High fructose corn syrup | 31.36 | 0-60 |
| Dextrose | 1.61 | 0-60 |
| Sodium stearyol lactylate | 0 | 0-1 |
| Polysorbate 60 Univar | 0.15 | 0-5 |
| Total | 100 | 100 |

### EXAMPLE 5

| Ingredient | Test wt. % | Broad Range wt. % |
|---|---|---|
| Palm kernel oil | 7.99 | 7-25 |
| Coconut oil | 0.76 | 0-25 |
| Polyaldo HGDS | 0 | 0-1 |
| Sodium caseinate | 1.2 | 0-5 |
| Calcium carbonate | 1.5 | 0.05-10 |
| Hydroxypropylmethyl cellulose | 0 | 0-1 |
| Xanthan gum | 0.25 | 0-1 |
| Guar gum | 0.22 | 0-1 |
| Potassium sorbate | 0 | 0-1 |
| Vanilla flavor | 0.35 | 0-1 |
| Cream flavor | 0.03 | 0-1 |
| Bavarian cream flavor | 0.05 | 0-1 |
| Sweet cream flavor | 0.005 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.02 | 0-1 |
| Water | 54.39 | 15-60 |
| High fructose corn syrup | 31.36 | 0-60 |
| Dextrose | 1.61 | 0-60 |
| Sodium stearyol lactylate | 0 | 0-1 |
| Polysorbate 60 Univar | 0.15 | 0-5 |
| Total | 100 | 100 |

### EXAMPLE 6

| Ingredient | Test wt. % | Broad Range wt. % |
|---|---|---|
| Palm kernel oil | 5.99 | 5-25 |
| Coconut oil | 0.76 | 0-25 |
| Polyaldo HGDS | 0 | 0-1 |
| Sodium casemate | 1.2 | 0-5 |
| Calcium carbonate | 1.5 | 0.05-10 |
| Hydroxypropylmethyl cellulose | 0 | 0-1 |
| Xanthan gum | 0.25 | 0-1 |
| Guar gum | 0.22 | 0-1 |
| Potassium sorbate | 0 | 0-1 |
| Vanilla flavor | 0.35 | 0-1 |
| Cream flavor | 0.03 | 0-1 |
| Bavarian cream flavor | 0.05 | 0-1 |
| Sweet cream flavor | 0.005 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.02 | 0-1 |
| Water | 56.39 | 15-60 |
| High fructose corn syrup | 31.36 | 0-60 |
| Dextrose | 1.61 | 0-60 |
| Sodium stearyol lactylate | 0 | 0-1 |
| Polysorbate 60 Univar | 0.15 | 0-5 |
| Total | 100 | 100 |

### EXAMPLE 7

| Ingredient | Test wt. % | Broad Range wt. % |
|---|---|---|
| Palm kernel oil | 16 | 10-25 |
| Coconut oil | 0 | 0-25 |
| Polyaldo HGDS | 0 | 0-1 |
| Sodium caseinate | 1.3 | 0-5 |
| Calcium carbonate | 1.5 | 0.05-10 |
| Hydroxypropylmethyl cellulose | 0 | 0-1 |
| Xanthan gum | 0.1 | 0-1 |
| Guar gum | 0.2 | 0-1 |
| Potassium sorbate | 0 | 0-1 |
| Vanilla flavor | 0.33 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.09 | 0-1 |
| Water | 48.13 | 15-60 |
| High fructose corn syrup | 31 | 0-60 |
| Dextrose | 1.01 | 0-60 |
| Sodium stearyol lactylate | 0 | 0-1 |
| Polysorbate 60 Univar | 0.33 | 0-5 |
| Total | 100 | 100 |

### EXAMPLE 8

| Ingredient | Test wt. % | Broad Range wt. % |
|---|---|---|
| Palm kernel oil | 15 | 10-25 |
| Coconut oil | 0 | 0-25 |
| Polyaldo HGDS | 0 | 0-1 |
| Sodium caseinate | 1.3 | 0-5 |
| Calcium carbonate | 1.5 | 0.05-10 |
| Hydroxypropylmethyl cellulose | 0 | 0-1 |
| Xanthan gum | 0.1 | 0-1 |
| Guar gum | 0.2 | 0-1 |
| Potassium sorbate | 0 | 0-1 |
| Vanilla flavor | 0.33 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.09 | 0-1 |
| Water | 49.13 | 15-60 |
| High fructose corn syrup | 32 | 0-60 |
| Dextrose | 1.01 | 0-60 |
| Sodium stearyol lactylate | 0 | 0-1 |
| Polysorbate 60 Univar | 0.33 | 0-5 |
| Total | 100 | 100 |

### EXAMPLE 9

| Ingredient | Test wt. % | Broad Range wt. % |
|---|---|---|
| Palm kernel oil | 12 | 10-25 |
| Coconut oil | 0 | 0-25 |
| Polyaldo HGDS | 0 | 0-1 |
| Sodium casemate | 1.3 | 0-5 |
| Calcium carbonate | 1.5 | 0.05-10 |
| Hydroxypropylmethyl cellulose | 0 | 0-1 |
| Xanthan gum | 0.1 | 0-1 |
| Guar gum | 0.2 | 0-1 |
| Potassium sorbate | 0 | 0-1 |
| Vanilla flavor | 0.33 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0.05 | 0-1 |
| Sodium hexamethaphospahte | 0.02 | 0-1 |
| Sorbitan monostearate | 0.09 | 0-1 |
| Water | 50.13 | 15-60 |
| High fructose corn syrup | 33 | 0-60 |
| Dextrose | 1.01 | 0-60 |
| Sodium stearyol lactylate | 0 | 0-1 |
| Polysorbate 60 Univar | 0.33 | 0-5 |
| Total | 100 | 100 |

### EXAMPLE 10

| Ingredient | Test wt. % | Broad Range wt. % |
|---|---|---|
| Palm kernel oil | 20 | 10-25 |
| Coconut oil | 0 | 0-25 |
| Polyaldo HGDS | 0 | 0-1 |
| Sodium casemate | 0.5 | 0-5 |
| Calcium carbonate | 1 | 0.05-10 |
| Hydroxypropylmethyl cellulose | 0 | 0-1 |
| Xanthan gum | 0.08 | 0-1 |
| Guar gum | 0 | 0-1 |
| Potassium sorbate | 0 | 0-1 |
| Vanilla flavor | 0 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0 | 0-1 |
| Sodium hexamethaphospahte | 0 | 0-1 |
| Sorbitan monostearate | 0 | 0-1 |
| Water | 77.42 | 15-80 |
| High fructose corn syrup | 0 | 0-60 |
| Dextrose | 0 | 0-60 |
| Artificial sweetener | 0 | 0-6 |
| Sodium stearyol lactylate | 1 | 0-5 |
| Polysorbate 60 Univar | 0 | 0-5 |
| Total | 100 | 100 |
| Whipping time/min. | 13 | 1-60 |
| Overrun % | 260 | 120-500 |
| Syneresis @ 4° C. | Small | |
| Syneresis @ 25° C. | Medium | |
| Bag time/min. | 15 | |

### EXAMPLE 11

| Ingredient | Test wt. % | Broad Range wt. % |
|---|---|---|
| Palm kernel oil | 20 | 10-25 |
| Coconut oil | 0 | 0-25 |
| Polyaldo HGDS | 0 | 0-1 |
| Sodium caseinate | 1 | 0-5 |
| Calcium carbonate | 1 | 0.05-10 |
| Hydroxypropylmethyl cellulose | 0 | 0-1 |
| Xanthan gum | 0.08 | 0-1 |
| Guar gum | 0 | 0-1 |
| Potassium sorbate | 0 | 0-1 |
| Vanilla flavor | 0 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0 | 0-1 |
| Sodium hexamethaphospahte | 0 | 0-1 |
| Sorbitan monostearate | 0 | 0-1 |
| Water | 76.92 | 15-80 |
| High fructose corn syrup | 0 | 0-60 |
| Dextrose | 0 | 0-60 |
| Artificial sweetener | 0 | 0-6 |
| Sodium stearyol lactylate | 1 | 0-5 |
| Polysorbate 60 Univar | 0 | 0-5 |
| Total | 100 | 100 |
| Whipping time/min. | 10 | 1-60 |
| Overrun % | 340 | 120-500 |
| Syneresis @ 4° C. | Small | |
| Syneresis @ 25° C. | Medium | |
| Bag time/min. | 40 | |

### EXAMPLE 12

| Ingredient | Test wt. % | Broad Range wt. % |
|---|---|---|
| Palm kernel oil | 20 | 10-25 |
| Coconut oil | 0 | 0-25 |
| Polyaldo HGDS | 0 | 0-1 |
| Sodium caseinate | 1 | 0-5 |
| Calcium carbonate | 1 | 0.05-10 |
| Hydroxypropylmethyl cellulose | 0 | 0-1 |
| Xanthan gum | 0.08 | 0-1 |
| Guar gum | 0 | 0-1 |
| Potassium sorbate | 0 | 0-1 |
| Vanilla flavor | 0 | 0-1 |
| Cream flavor | 0 | 0-1 |
| Bavarian cream flavor | 0 | 0-1 |
| Sweet cream flavor | 0 | 0-1 |
| Sodium chloride | 0 | 0-1 |
| Disodium phosphate | 0 | 0-1 |
| Sodium hexamethaphospahte | 0 | 0-1 |
| Sorbitan monostearate | 0 | 0-1 |
| Water | 41.92 | 15-80 |
| High fructose corn syrup | 35 | 0-60 |
| Dextrose | 0 | 0-60 |
| Artificial sweetener | 0 | 0-6 |
| Sodium stearyol lactylate | 1 | 0-5 |
| Polysorbate 60 Univar | 0 | 0-5 |
| Total | 100 | 100 |
| Whipping time/min. | 10 | 1-60 |
| Overrun % | 375 | 120-500 |
| Syneresis @ 4° C. | Fully Stable | |
| Syneresis @ 25° C. | Small | |
| Bag time/min. | 75 | |

For example 10, the visual observations were a creamy foam with good body, very good peaking, and good spreading properties. For example 11, the visual observations were a desirable stiffness, excellent peaking, and very good spreading properties. For example 12, the visual observations were a desirable stiffness, excellent peaking, and very good spreading properties.

### EXAMPLE 13

| Ingredient | Desired Range wt. % | Broad Range wt. % |
|---|---|---|
| Palm kernel oil | 18-20 | 10-30 |
| Sodium casemate | 0-1 | 0-2 |
| Calcium carbonate | 0.5-1 | 0.5-2 |
| Xanthan gum | 0.05-0.1 | 0.02-2 |
| Water | 35-80 | 30-85 |
| High fructose corn syrup | 0-55 | 0-60 |
| Sodium stearyol lactylate | 0.5-1 | 0.15-1.5 |
| Total | 100 | 100 |

### EXAMPLE 14

| Ingredient | Desired Range wt. % | Broad Range wt. % |
|---|---|---|
| Palm kernel oil | 10-18 | 5-30 |
| Coconut oil | 10-18 | 5-30 |
| Sodium caseinate | 0.5-1.5 | 0-2 |
| Calcium carbonate | 0.5-2.0 | 0.5-5 |
| Xanthan gum | 0.05-0.1 | 0.02-2 |
| Guar gum | 0.1-0.2 | 0.05-3 |
| Water | 45-55 | 40-60 |
| Dextrose | 0-5 | 0-10 |
| High fructose corn syrup | 10-20 | 10-40 |
| Corn syrup 36DE43 | 10-20 | 5-25 |
| Polysorbate 60 | 0.1-0.3 | 0.05-0.5 |
| Sorbitan monostearate | 0.1-0.2 | 0.05-0.5 |
| Flavor | 0.5-1 | 0-2 |
| Total | 100 | 100 |

Performance Evaluation

Continuously Whipped Topping

| WHIPPED | | Quality Score | Quality Score | | |
|---|---|---|---|---|---|
| TOPPING | PCC | (3 days | (12 days | Over- | Pene- |
| FORMULA | (Y/N) | at 4° C.) | at 4° C.) | run | trometer |
| Control 18% | N | 2.5 | 2 | 415 | 40 |
| Fat | | | | | |
| Control 16% | N | 1 | 1 | 400 | 64 |
| Fat | | | | | |
| Control 14% | N | 1 | 1 | 404 | 64 |
| Fat | | | | | |
| PCC 16% Fat | Y | 3 | 2.5 | 395 | 36 |
| PCC 14% Fat | Y | 2 | 2 | 398 | 47 |

Quality Scores:
1 = unacceptable - very soft and coarse texture, unable to hold peak
2 = acceptable - soft and coarse but able to hold peak
3 = good - moderate firmness with grainy texture peak with sharp edges
4 = very good - firm with smooth texture peak with sharp edges
5 = excellent - firm with satin smooth texture sharp edges and teardrop peak
Overrun
Target: 400% +/− 25%
Penetrometer
Target 42 mm +/− 6 mm
higher value = softer
lower value = firmer

Calcium carbonate can be added to oil phase; however, this is not required. As can be appreciated, other flavorings can be used. As indicated in Example 13, the protein content can be zero, thus creating a whipped topping without the use of a protein source. Example 13 also illustrated that the whipped topping can be formed without including high fructose syrup or other natural sweetener. As such, the water content can be as high as 80% and still form a whippable and stable topping. As indicated in Example 14, the composition that includes calcium carbonate can have both improved fat reduction and improved performance. The calcium carbonate is typically precipitated calcium carbonate (PCC). The PCC is can be non-coated or coated (i.e. surface modified) depending on the desired properties of the finished product. The surface properties of can be selected in order to manipulate the whipping time and texture of the final product. The coatings, when used, may be applied via surface deposition on the calcium carbonate in advance addition to the emulsion formulation or may be imparted during the formation of the emulsion.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

We claim:

1. An edible foamable composition that is whippable and is stable at a temperature above freezing, said composition comprising fat, emulsifier, water, and calcium carbonate particles.

2. The composition as defined in claim 1, further including one or more additives selected from the group consisting of preservatives, protein, salt, flavoring, coloring agent, sweetener, stabilizer and thickener.

3. The composition as defined in claim 1, wherein said fat content of the edible foam composition is about 0.1%-50% by weight of said composition.

4. The composition as defined in claim 1, wherein said fat includes one or more compounds selected from the group consisting of palm oil, palm kernel oil, coconut oil, milk fat, soy oil, cottonseed oil, canola oil, corn oil, sunflower oil, safflower oil, nut oil, beans, and animal fat.

5. The composition as defined in claim 1, wherein said calcium carbonate particle content is generally about 0.01%-10% by weight of said composition.

6. The composition as defined in claim 1, wherein said calcium carbonate particles include precipitated calcium carbonate, said calcium carbonate particles can be coated, non-coated, or combinations thereof.

7. The composition as defined in claim 1, wherein said calcium carbonate particles have an average particle size of about 0.001-10 microns.

8. The composition as defined in claim 1, wherein a content of said emulsifier is about 0.001%-5% by weight of said composition.

9. The composition as defined in claim 1, wherein said emulsifier includes one or more compounds selected from the group consisting of lecithin, hydrolyzed lecithin; mono-, di-, or poly-glycerides of fatty acids, such as stearine and palmitin mono- and di-glycerides, polyoxyethylene ethers of fatty esters of polyhydric alcohols, polyoxyethylene ethers of sorbitan monostearate, Polysorbate 60, polyoxyethylene ethers of sorbitan monooleate, Polysorbate 80; fatty esters of polyhydric alcohols, sorbitan monostearate, sorbitan tristearate; polyglycerol esters of mono- and di-glycerides, hexaglyceryl distearate; mono- and/or di-esters of glycols, propylene glycol monostearate, propylene glycol monopalmitate, succinoylated monoglycerides, esters of carboxylic acids, lactic, citric, and tartaric acids with the mono- and di-glycerides of fatty acids such as glycerol lacto palmitate and glycerol lacto stearate, calcium stearoyl lactylates, sodium stearoyl lactylates diacetyltartaric esters of fatty acids, “DATEMs”.

10. The composition as defined in claim 1, wherein a content of said water is about 25%-85% by weight of said composition.

11. The composition as defined in claim 1, further including stabilizer, a content of said stabilizer is about 0.001%-5% by weight of said composition.

12. The composition as defined in claim 11, wherein said stabilizer includes one or more compounds selected from the group consisting of cellulose, gum arabic, carboxymethylcellulose (CMC), gellan gum, guar gum, xanthan gum, alginate, locust bean gum, hydrophilic colloids, carrageenan, methylcellulose (MCC), ethylcellulose, hydroxy-propylmethylcellulose, microcrystalline cellulose.

13. The composition as defined in claim 1, further including protein, a content of said protein is 0.01%-15% by weight of said composition.

14. The composition as defined in claim 1, further including sweetener, a content of said sweetener is 0.01%-75% by weight of said composition.

15. The composition as defined in claim 14, wherein said sweetener includes one or more compounds selected from the group consisting of lactose, sucrose, fructose, dextrose, sucrose, trehalose, maltose, sugar syrups, polydextrose, maltitol, erythritol, xylitol, mannitol, isomalt, lactitol, glycerin, propylene glycol, sorbitol, honey granule, honey powder, corn syrup, high fructose corn syrup, malt, and hydrolyzed corn syrup, liquid honey.

16. The composition as defined in claim 1, wherein said composition is stable in a whipped form for at least 0.5 days at temperatures of above freezing and up to 30° C., said composition in said whipped form having an overrun of at least 150%.

17. The composition as defined in claim 1, comprising by weight percent:

| | |
|---|---|
| Oil and/or fat | 5-40 |
| Emulsifier | 0.001-2 |
| Protein | 0-8 |
| Calcium carbonate | 0.05-15 |
| Stabilizers/Thickeners | 0.001-2 |
| Preservative | 0-1.5 |
| Flavoring | 0.01-0.1 |
| Salt | 0-1.5 |
| Water | 10-80 |
| Sweetener | 0.001-75. |

18. The composition as defined in claim 1, comprising by weight percent:

| | |
|---|---|
| Oil and/or fat | 12-20 |
| Emulsifier | 0.4-0.8 |
| Protein | 0.5-2 |
| Calcium carbonate | 0.3-0.7 |
| Stabilizers/Thickeners | 0.01-1 |
| Preservative | 0.05-0.2 |
| Flavoring | 0.01-0.1 |
| Salt | 0.05-0.15 |
| Water | 15-30 |
| Sweetener | 40-60. |

19. The composition as defined in claim 1, comprising by weight percent:

| | |
|---|---|
| Oil and/or fat | 10-30 |
| Emulsifier | 0.15-1.5 |
| Protein | 0-2 |
| Calcium carbonate | 0.5-2 |
| Stabilizers/Thickeners | 0.02-2 |
| Water | 30-85 |
| Sweetener | 0-55. |

20. The composition as defined in claim 1, comprising by weight percent:

| | |
|---|---|
| Oil and/or fat | 18-20 |
| Emulsifier | 0.5-1 |
| Protein | 0-1 |
| Calcium carbonate | 0.5-1 |
| Stabilizers/Thickeners | 0.05-0.1 |
| Water | 35-80 |
| Sweetener | 0-55. |

21. A method for forming an edible foamable composition that is whippable and is stable at a temperature above freezing comprising the steps of:
a) combining fat, emulsifier, water, and calcium carbonate particles to form a mixture,
b) mixing said mixture at a temperature that is greater than a freezing point of said mixture to form a whipped mixture having an overrun of at least about 150%,
wherein said whipped mixture is stable and maintains said overrun of at least 150% at a temperature above a freezing point of said whipped mixture for at least 0.5 days.

22. The method as defined in claim 21, further including the step of adding sweetener, stabilizer, thickener, or combinations thereof.

23. The method as defined in claim 21, wherein at least a portion of said calcium carbonate particles are added to the mixture during said mixing step.
